(19) United States
(12) Patent Application Publication
(10) Pub. No.: US 2025/0117810 A1
(43) Pub. Date: Apr. 10, 2025

(54) AUTOMATING THE MONITORING OF A LARGE POPULATION OF FIELD SYSTEMS

(71) Applicant: Schlumberger Technology Corporation, Sugar Land, TX (US)

(72) Inventors: Denis Syresin, Sugar Land, TX (US); Jean-Philippe Hussenet, Sugar Land, TX (US); Roman Vladimirovich Korkin, Katy, TX (US)

(21) Appl. No.: 18/906,919

(22) Filed: Oct. 4, 2024

Related U.S. Application Data
(60) Provisional application No. 63/588,190, filed on Oct. 5, 2023.

(51) Int. Cl. G06Q 30/018; E21B 41/00; G06Q 10/0635

(52) U.S. Cl. CPC G06Q 30/018; E21B 41/0035; G06Q 10/0635; E21B 2200/20

(57) ABSTRACT

Embodiments presented provide for a system and method for automating the monitoring of a large population of field systems. The recovery of data pertaining to each of the field systems may be used in structural health monitoring to increase project safety, improve maintenance of the facilities, and increase economic returns.

### CROSS-REFERENCE TO RELATED APPLICATIONS

This application claims priority to and the benefit of U.S. Provisional Patent Application Ser. No. 63/588,190, entitled “AUTOMATING THE MONITORING OF A LARGE POPULATION OF FIELD SYSTEMS,” filed Oct. 5, 2023, which is hereby incorporated by reference in its entirety for all purposes.

### FIELD OF THE DISCLOSURE

Aspects of the disclosure relate to monitoring of field systems. More specifically, aspects of the disclosure relate to monitoring of a large population of field systems used in hydrocarbon recovery systems to enable predictive maintenance and trends among the systems.

### BACKGROUND

Structural health monitoring (SHM) of a large population system is the growing technology to control distributed systems of sensors. It provides clear benefits and knowledge about the behavior of the full system and its single elements. The main idea of SHM technology lies in feature extraction and feature mapping in a way that the resultant map can be easily visualized and processed to identify outliers, detect damage, and predict the future behaviors, trends and patterns for systems elements.

For the equipment installed in hydrocarbon recovery operations, currently there are no systems that combine data obtained from various field systems. In this instance, the data that is obtained from the systems is lost. While not immediately apparent, the trends and behavioral patterns that may be present between different locations are also lost as the data is never combined between different locations. The loss of data and the insights that the data provides increases inefficiency and, overall, economic costs. For example, if a specific component is found to be compromised in the field at each wellbore after a specific amount of time, current operations in hydrocarbon operations rely on replacing each component upon failure. Waiting until failure may cause an unplanned wellbore outage, severely impacting overall recovery and economic operations. It would be advantageous to be able to replace a compromised component under planned circumstances. Continuing with the example, ordering the failed component in bulk may prove to be advantageous from a cost perspective. The cost benefits do not conclude with this advantage. If repairs can be made during normal field activities, then wellbore outages are minimized, thereby increasing the economic advantages. In more advanced analysis, if replacement of the component can be done near the point of component failure, then premature retirement of components is avoided, increasing economic advantages even further.

Currently, simultaneous structural health monitoring of hundreds and thousands of wells is not performed. Activities to combine data among large scale populations of hydrocarbon recovery systems are not performed. Conventional activities are even more compromised as there is no standard system that is used to retrieve data on a uniform basis, thereby further complicating matters. Thus, there is a need to collect data on a uniform basis to allow standardization.

There is a need to provide an apparatus and methods that retains data in a uniform format, compared to the piecemeal methods currently used in conventional hydrocarbon recovery operations.

There is a further need to provide apparatus and methods that do not have the drawbacks discussed above, namely incomplete data acquisition, inability to accurately predict structural health of systems.

There is a still further need to reduce economic costs associated with operations and apparatus described above with conventional hydrocarbon recovery operations.

There is a further need to accurately use data present in large scale hydrocarbon recovery systems to further objectives related recovery operations.

### SUMMARY

So that the manner in which the above recited features of the present disclosure can be understood in detail, a more particular description of the disclosure, briefly summarized below, may be had by reference to embodiments, some of which are illustrated in the drawings. It is to be noted that the drawings illustrate only typical embodiments of this disclosure and are; therefore, not to be considered limiting of its scope, for the disclosure may admit to other equally effective embodiments without specific recitation. Accordingly, the following summary provides just a few aspects of the description and should not be used to limit the described embodiments to a single concept.

In one embodiment, a method to monitor a distribution of hydrocarbon recovery systems is disclosed. The method may comprise acquiring data from each of the element of hydrocarbon recovery systems. The method may also comprise transferring the data from each of the distribution of the hydrocarbon recovery systems to a server that is remote from the hydrocarbon recovery systems. The method may also comprise preprocessing datasets from the data. The method may also comprise conducting a feature selection of the data. The method may also comprise generating a self-organizing map pertaining to the feature selection of the data. The method may also comprise displaying the self-organizing map and encoding the map based on known data labeling. The method may also comprise introducing new events to the self-organizing map. The method may also comprise displaying the new events on the map. The method may also comprise tracking the new event from measurement unit by a path on the map. The method may also comprise regenerating the self-organizing map incorporating the new events to monitor map evolution. The method may also comprise conducting at least one of a behavior forecast and a predictive risk evaluation on the hydrocarbon recovery systems or inner subsystem.

In another example embodiment, an article of manufacture configured to store a set of instructions that may be read on a computer is disclosed. In this embodiment, the article of manufacture is configured to have a non-volatile memory, the set of instructions including a method to monitor a distribution of hydrocarbon recovery systems. The method performed by the article of manufacture includes acquiring data from each of the distribution of hydrocarbon recovery systems. The method performed by the article of manufacture may further comprise transferring the data from each element of the distribution of the hydrocarbon recovery systems to a server that is remote from the hydrocarbon recovery systems. The method performed by the article of manufacture may further comprise preprocessing datasets from the data. The method performed by the article of manufacture may further comprise conducting a feature selection of the data. The method performed by the article of manufacture may further comprise generating a self-organizing map pertaining to the feature selection of the data. The method performed by the article of manufacture may further comprise displaying the self-organizing map and encoding the map based on known data labeling. The method performed by the article of manufacture may further comprise introducing new events to the self-organizing map. The method performed by the article of manufacture may further comprise displaying the new events on the map. The method performed by the article of manufacture may further comprise regenerating the self-organizing map incorporating the new events to monitor map evolution and conducting at least one of a behavior forecast and a predictive risk evaluation on the hydrocarbon recovery systems or inner subsystem.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the drawings. It is to be noted; however, that the appended drawings illustrate only typical embodiments of this disclosure and are; therefore, not be considered limiting of its scope, for the disclosure may admit to other equally effective embodiments.

FIG. 1 is a method for automating the monitoring of a large population of field systems in a hydrocarbon recovery operation in one embodiment of the disclosure.

FIG. 2 is a computer apparatus used in performing methods and controlling apparatus for the method of FIG. 1.

To facilitate understanding, identical reference numerals have been used, where possible, to designate identical elements that are common to the figures (“FIGS”). It is contemplated that elements disclosed in one embodiment may be beneficially utilized on other embodiments without specific recitation.

### DETAILED DESCRIPTION

In the following, reference is made to embodiments of the disclosure. It should be understood, however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the claims except where explicitly recited in a claim. Likewise, reference to “the disclosure” shall not be construed as a generalization of inventive subject matter disclosed herein and should not be considered to be an element or limitation of the claims except where explicitly recited in a claim.

Although the terms first, second, third, etc., may be used herein to describe various elements, components, regions, layers and/or sections, these elements, components, regions, layers and/or sections should not be limited by these terms. These terms may be only used to distinguish one element, components, region, layer or section from another region, layer or section. Terms such as “first”, “second” and other numerical terms, when used herein, do not imply a sequence or order unless clearly indicated by the context. Thus, a first element, component, region, layer or section discussed herein could be termed a second element, component, region, layer or section without departing from the teachings of the example embodiments.

When an element or layer is referred to as being “on,” “engaged to,” “connected to,” or “coupled to” another element or layer, it may be directly on, engaged, connected, coupled to the other element or layer, or interleaving elements or layers may be present. In contrast, when an element is referred to as being “directly on,” “directly engaged to,” “directly connected to,” or “directly coupled to” another element or layer, there may be no interleaving elements or layers present. Other words used to describe the relationship between elements should be interpreted in a like fashion. As used herein, the term “and/or” includes any and all combinations of one or more of the associated listed terms.

Some embodiments will now be described with reference to the figures. Like elements in the various figures will be referenced with like numbers for consistency. In the following description, numerous details are set forth to provide an understanding of various embodiments and/or features. It will be understood, however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to more clearly describe certain embodiments.

Aspects of methods described may be included onto a non-volatile memory system. For definitional purposes, a non-volatile memory system may be a memory system that does not wipe clean after termination of electrical power to the system. Examples of non-volatile memory systems may be compact disks, solid-state drives and universal serial bus devices. These memory systems may be used to store program executable method steps for a computer, server or computing arrangement.

Aspects of the disclosure present a technological workflow for remote monitoring and control of large-population field systems containing numerous sensors or measurement units. The field systems can be installed at oil & gas wells or other energy service or production applications. Other energy service or production applications can include Geothermal operations or Carbon Capture Utilization and Sequestration applications. As will be understood, this workflow may be applicable to be used at different types of hydrocarbon recovery operations. Aspects may also be used for other distributed workplaces. In some embodiments, carbon sequestration activities may be monitored over several points or injection points through embodiments disclosed herein. At each worksite (wellbore) or series of wellbores, instrumentation is installed to perform various functions. Such functions may include determining operating temperatures, operating pressures, motor speeds and frequencies, fluid flow, fluid composition, equipment activity reports, maintenance activities, etc. Data may be generated by the various sensors and recorded. Currently, each wellbore is treated individually. In aspects of the disclosure, data generated at each wellbore is recorded and then data is transferred to a centralized location. The data may be transferred through a wired connection, a wireless connection (such as a cell phone connection, radio or satellite connection) or a combination of the above described communication methods. In embodiments, the datasets are multi-dimensional single value or time series data. The data may be delivered to remote servers or storages to be automatically mapped, labeled, and visualized.

In some aspects of the disclosure, the datasets may be standardized such that data in each data set is easily comparable to other datasets. In some embodiments, data clusterization methods or self-organizing map, hereinafter (“SOM”) or auto-encoder, hereinafter (AESOM) are used.

In embodiments, the approaches are capable of automatically grouping similar elements together and reducing the multi-dimensional dataset's space to lower dimension latent space such as 2D/3D to simplify further analysis. In embodiments, taking advantage of the mapped dataset, the results available from multiple measurements can be visualized in 2D/3D domain for certain sub-groups of acquired datasets. Every new measurement can be added to this map and, thus automatically be classified and grouped based on its data.

During long-period monitoring time, the change of the single measurement unit at the map or the map itself will indicate the variation of the single element or whole large-population system and may indicate some changes in the system state, that might be “health”, environmental conditions, or any other anomaly. As will be understood, emphasis may be placed on various factors for analysis. If, for example, at some locations, diesel engines are used to provide a motivational force for operations, the diesel engines, when running, may emit gaseous byproducts. These gasses may be monitored over time. By combining data from multiple wellsites, an environmental “picture” may be developed, where gaseous emissions may be larger in some areas and smaller in others. To this end, if a gaseous emission is to be monitored and limited by local officials according to an air permit, it may be desired to prevent non-attainment of air emissions parameters by limiting run times to the diesel engines. Often times, such air permits will be developed for an entire area, rather than a specific well. When obtaining data from all sources at the wellsite, accurate monitoring of the entire area provides a more accurate estimate of emissions. Thus, through embodiments described herein, air emission attainment parameters may be achieved, while in conventional technologies, it is unknown about the amount of emissions for the site until all wellsites are added together. At the time of discovery that the emissions limits were exceeded, no remedial measures may be undertaken and the company running the wellsite may receive a substantial fine.

Other types of monitoring may occur, such as running speed for pumps and comparing the amount of run time to manufacturer guidelines. Once certain thresholds are reached, maintenance may be called to perform routine maintenance activities. In embodiments of the disclosure, similar maintenance procedures may be performed at multiple wellsites; therefore, a single mobilization charge may be incurred by the owner of the site as multiple wellbores may be maintained in a single trip rather than conducting piecemeal operations which are uneconomic.

In embodiments, the change of position for the selected measurements, i.e unit/well/pad, will also indicate the evolution and change of conditions for selected unit/well/pad in time and can be helpful to forecast measurement trends and early detect undesirable/desirable measurements happening over time.

In further embodiments, through labeling each dataset with certain parameters (e.g. risk of malfunction), a map with label-based color encoding may be developed to easily monitor and select units/wells with higher risk of malfunction.

As an example of the application, we consider a set of Multiphase Flowmeters (MPFM) installed at oil & gas wells, equipped with a data transfer system and connected to a remote server. As a single measurement dataset, we can analyze the combination of raw sensors data, measured flowrates, signal processing metrics, well information, fluid properties, etc.

The SOM assumes natural generalization to a so-called Self-Organizing Time Map (SOTM), which performs exploratory temporal structure analysis. This allows revealing the properties of temporal structural changes in the data. In particular, the slow variation of the parameters of the multiphase flow over time needs to be analyzed to discriminate essential and non-essential variation of the flow rate conditions and make a decision based on this discrimination.

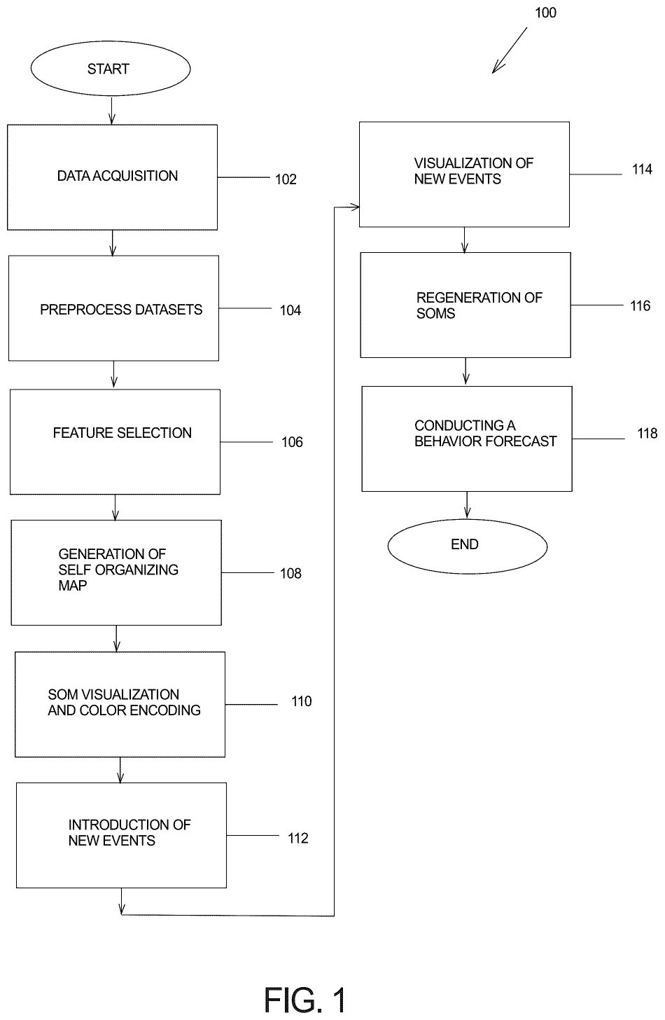

Referring to FIG. 1, one example embodiment of the workflow method 100 is presented. At 102, the method calls for multi-dimensional data acquisition performed during each measurement and data transfer to the remote server. At 104, the method proceeds with preprocessing of datasets including data cleaning, labeling and feature extraction. At 106, the method proceeds with conducting relevant feature selection and Relevant units selection based on the problem. At 108, the method proceeds with generation of a self-organizing map selected data. At 110, the method proceeds with SOM visualization and color encoding based on the known data labeling. At 112, the method proceeds with introduction of the new events. Automated classification of new events are performed with existing maps. At 114, the method continues with visualization and monitoring of new events at the map and making a decision based on the closeness to desired or undesired position. In some embodiments, the method may include tracking the new event from measurement unit by a path on the map. At 116, the method further proceeds with re-generation of SOMs using newly added events to monitor large-population map evolution and changes. At 118, the method further provides for conducting a behavior forecast and predictive risk evaluation based on the instrument/well trajectory within SOM.

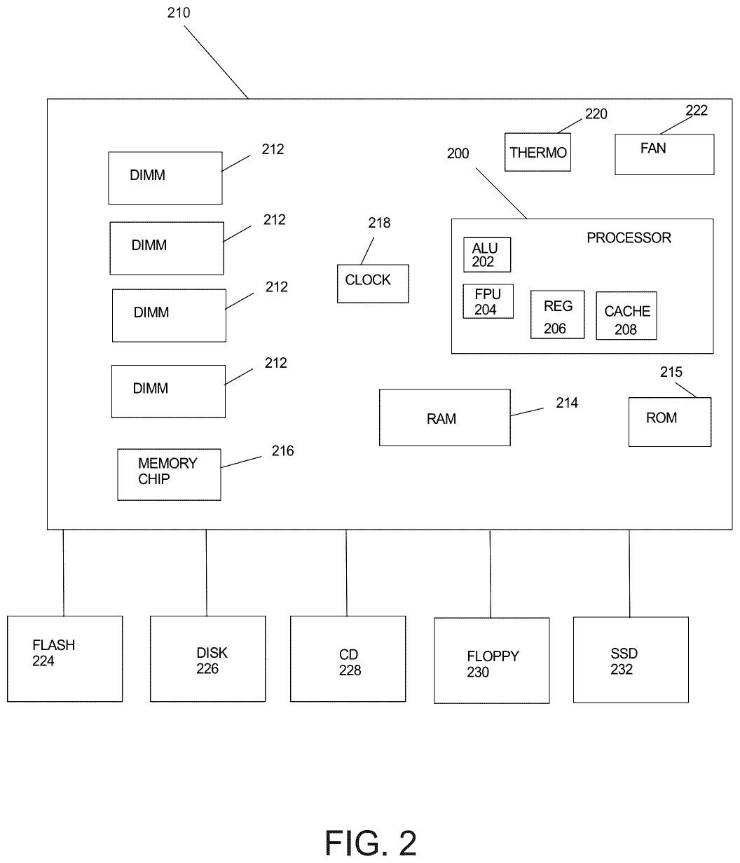

In such embodiments, referring to FIG. 2, a computing apparatus used in the control of equipment of FIG. 1 is illustrated. In FIG. 2, a processor 200 is provided to perform computational analysis for instructions provided. The instruction provided, code, may be written to achieve the desired goal and the processor may access the instructions. In other embodiments, the instructions may be provided directly to the processor 200.

In other embodiments, other components may be substituted for generalized processors. These specifically designed components, known as application specific integrated circuits (“ASICs”) are specially designed to perform the desired task. As such, the ASIC's generally have a smaller footprint than generalized computer processors. The ASIC's, when used in embodiments of the disclosure, may use field programmable gate array technology, that allow a user to make variations in computing, as necessary. Thus, the methods described herein are not specifically held to a precise embodiment, rather alterations of the programming may be achieved through these configurations.

In embodiments, when equipped with a processor 200, the processor may have arithmetic logic unit (“ALU”) 202, a floating point unit (“FPU”) 204, registers 206 and a single or multiple layer cache 208. The arithmetic logic unit 202 may perform arithmetic functions as well as logic functions. The floating point unit 204 may be math coprocessor or numeric coprocessor to manipulate number for efficiently and quickly than other types of circuits. The registers 206 are configured to store data that will be used by the processor during calculations and supply operands to the arithmetic unit and store the result of operations. The single or multiple layer caches 208 are provided as a storehouse for data to help in calculation speed by preventing the processor 200 from continually accessing random access memory (“RAM”).

Aspects of the disclosure provide for the use of a single processor 200. Other embodiments of the disclosure allow for the use of more than a single processor. Such configurations may be called a multi-core processor where different functions are conducted by different processors to aid in calculation speed. In embodiments, when different processors are used, calculations may be performed simultaneously by different processors, a process known as parallel processing.

The processor 200 may be located on a motherboard 210. The motherboard 210 is a printed circuit board that incorporates the processor 200 as well as other components helpful in processing, such as memory modules (“DIMMS”) 212, random access memory 214, read only memory, non-volatile memory chips 216, a clock generator 218 that keeps components in synchronization, as well as connectors for connecting other components to the motherboard 210. The motherboard 210 may have different sizes according to the needs of the computer architect. To this end, the different sizes, known as form factors, may vary from sizes from a cellular telephone size to a desktop personal computer size. The motherboard 210 may also provide other services to aid in functioning of the processor, such as cooling capacity. Cooling capacity may include a thermometer 220 and a temperature-controlled fan 222 that conveys cooling air over the motherboard 210 to reduce temperature.

Data stored for execution by the processor 200 may be stored in several locations, including the random-access memory 214, read only memory, flash memory 224, computer hard disk drives 226, compact disks 228, floppy disks 230 and solid state drives 232. For booting purposes, data may be stored in an integrated chip called an EEPROM, that is accessed during start-up of the processor. The data, known as a Basic Input/Output System (“BIOS”), contains, in some example embodiments, an operating system that controls both internal and peripheral components.

Different components may be added to the motherboard or may be connected to the motherboard to enhance processing. Examples of such connections of peripheral components may be video input/output sockets, storage configurations (such as hard disks, solid state disks, or access to cloud-based storage), printer communication ports, enhanced video processors, additional random access memory and network cards.

The processor and motherboard may be provided in a discrete form factor, such as personal computer, cellular telephone, tablet, personal digital assistant or other component. The processor and motherboard may be connected to other similar computing arrangements in networked form. Data may be exchanged between different sections of the network to enhance desired outputs. The network may be a public computing network or may be a secured network where only authorized users or devices may be allowed access.

As will be understood, method steps for completion may be stored in the random access memory, read only memory, flash memory, computer hard disk drives, compact disks, floppy disks and solid state drives.

Different input/output devices may be used in conjunction with the motherboard and processor. Input of data may be through a keyboard, voice, Universal Serial Bus (“USB”) device, mouse, pen, stylus, Firewire, video camera, light pen, joystick, trackball, scanner, bar code reader and touch screen. Output devices may include monitors, printers, headphones, plotters, televisions, speakers and projectors.

Aspects of methods described may be included onto a non-volatile memory system. For definitional purposes, a non-volatile memory system may be a memory system that does not wipe clean after termination of electrical power to the system. Examples of non-volatile memory systems may be compact disks, solid-state drives and universal serial bus devices. These memory systems may be used to store program executable method steps for a computer, server or computing arrangement.

Aspects of the claims will now be disclosed. Such aspects should not be considered to limit the overall disclosure. In one embodiment, a method to monitor a distribution of hydrocarbon recovery systems is disclosed. The method may comprise acquiring data from each of the distribution of hydrocarbon recovery systems. The method may also comprise transferring the data from each of the distribution of the hydrocarbon recovery systems to a server that is remote from the hydrocarbon recovery systems. The method may also comprise preprocessing datasets from the data. The method may also comprise conducting a feature selection of the data. The method may also comprise generating a self-organizing map pertaining to the feature selection of the data. The method may also comprise displaying the self-organizing map and encoding the map based on known data labeling. The method may also comprise introducing new events to the self-organizing map. The method may also comprise displaying the new events on the map. The method may also comprise tracking the new event from measurement unit by a path on the map. The method may also comprise regenerating the self-organizing map incorporating the new events to monitor map evolution. The method may also comprise conducting at least one of a behavior forecast and a predictive risk evaluation on the hydrocarbon recovery systems.

In another example embodiment, the method may be performed wherein the data acquired from each of the distribution of hydrocarbon recovery systems is multi-dimensional.

In another example embodiment, the method may be performed wherein the preprocessing includes data cleaning.

In another example embodiment, the method may be performed wherein the preprocessing includes labeling.

In another example embodiment, the method may be performed wherein the preprocessing includes feature extraction.

In another example embodiment, the method may be performed wherein the feature selection is related to a user inquiry.

In another example embodiment, the method may be performed wherein the self-organizing map is color coded.

In another example embodiment, the method may be performed wherein the introducing new events to the self-organizing map is performed on an automated classification.

In another example embodiment, the method may be performed wherein the data pertains to structural health monitoring.

In another example embodiment, the method may be performed wherein the data is formatted in lower-latency space matrix as two-dimensional or three-dimensional.

In another example embodiment, the method may be performed wherein acquired data and/or the self-organizing map includes a time element.

In another example embodiment, the method may be performed wherein the data is related to failure risk probability.

In another example embodiment, the method may be performed wherein an algorithm is used to reduce multi-dimensionality and data grouping/clusterization.

In another example embodiment, an article of manufacture configured to store a set of instructions that may be read on a computer is disclosed. In this embodiment, the article of manufacture is configured to have a non-volatile memory, the set of instructions including a method to monitor a distribution of hydrocarbon recovery systems. The method performed by the article of manufacture includes acquiring data from each of the distribution of hydrocarbon recovery systems. The method performed by the article of manufacture may further comprise transferring the data from each of the distribution of the hydrocarbon recovery systems to a server that is remote from the hydrocarbon recovery systems. The method performed by the article of manufacture may further comprise preprocessing datasets from the data. The method performed by the article of manufacture may further comprise conducting a feature selection of the data. The method performed by the article of manufacture may further comprise generating a self-organizing map pertaining to the feature selection of the data. The method performed by the article of manufacture may further comprise displaying the self-organizing map and encoding the map based on known data labeling. The method performed by the article of manufacture may further comprise introducing new events to the self-organizing map. The method performed by the article of manufacture may further comprise displaying the new events on the map. The method performed by the article of manufacture may monitor evolution of single measurement units by adding and classifying newly coming events on the map. The method performed by the article of manufacture may further comprise regenerating the self-organizing map incorporating the new events to monitor map evolution. The method performed by the article of manufacture may conduct at least one of a behavior forecast and a predictive risk evaluation on the hydrocarbon recovery systems.

In another example embodiment, the article of manufacture may be configured wherein the article is one of a universal serial device, a compact disk, a solid-state drive and a computer hard disk.

In another example embodiment, the article of manufacture may be configured wherein the data used in the method performed relates to structural health monitoring data.

In another example embodiment, the article of manufacture may be configured wherein the data is formatted in lower-latency space matrix such as a two-dimensional and three-dimensional matrix.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may be varied in many ways. Such variations are not to be regarded as a departure from the disclosure, and all such modifications are intended to be included within the scope of the disclosure.

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

What is claimed is:

1. A method to monitor a distribution of field systems, comprising:
acquiring data from each of the distribution of hydrocarbon recovery systems;
transferring the data from each of the distribution of the hydrocarbon recovery systems to a server that is remote from the hydrocarbon recovery systems;
preprocessing datasets from the data;
conducting a feature selection of the data;
generating a self-organizing map pertaining to the feature selection of the data;
displaying the self-organizing map and encoding the map based on known data labeling;
introducing new events to the self-organizing map;
displaying the new events on the map;
tracking the new event from measurement unit by a path on the map;
regenerating the self-organizing map incorporating the new events to monitor map evolution; and
conducting at least one of a behavior forecast and a predictive risk evaluation on the hydrocarbon recovery systems or inner subsystems.

2. The method according to claim 1, wherein the data acquired from each of the distribution of hydrocarbon recovery systems is multi-dimensional.

3. The method according to claim 1, wherein the preprocessing includes data cleaning.

4. The method according to claim 1, wherein the preprocessing includes labeling.

5. The method according to claim 1, wherein the preprocessing includes feature extraction.

6. The method according to claim 1, wherein the feature selection is related to a user inquiry.

7. The method according to claim 1, wherein the self-organizing map is color coded.

8. The method according to claim 1, wherein the introducing new events to the self-organizing map is performed on an automated classification.

9. The method according to claim 1, wherein the data pertains to structural health monitoring.

10. The method according to claim 1, wherein the data is formatted in one of a two-dimensional and three-dimensional matrix.

11. The method according to claim 1, wherein the self-organizing map includes a time element.

12. The method according to claim 1, wherein the data is related to failure risk probability.

13. The method according to claim 1, wherein the data acquired from each of the distribution of hydrocarbon recovery systems has a time-series format.

14. The method according to claim 2, wherein during the method an algorithm is used to reduce multi-dimensionality.

15. An article of manufacture configured to store a set of instructions that may be read on a computer, the article of manufacture having a non-volatile memory, the set of instructions including a method to monitor a distribution of field systems, comprising:
acquiring data from each of the distribution of hydrocarbon recovery systems;
transferring the data from each of the distribution of the hydrocarbon recovery systems to a server that is remote from the hydrocarbon recovery systems;
preprocessing datasets from the data;
conducting a feature selection of the data;
generating a self-organizing map pertaining to the feature selection of the data;
displaying the self-organizing map and encoding the map based on known data labeling;
introducing new events to the self-organizing map;
displaying the new events on the map;
regenerating the self-organizing map incorporating the new events to monitor map evolution; and
conducting at least one of a behavior forecast and a predictive risk evaluation on the hydrocarbon recovery systems.

16. The article of manufacture according to claim 15, wherein the article of manufacture is one of a universal serial device, a compact disk, a solid-state drive and a computer hard disk.

17. The article of manufacture according to claim 15, wherein the data used in the method performed relates to structural health monitoring data.

18. The article of manufacture according to claim 15, wherein the data is formatted in one of a two-dimensional and three-dimensional matrix.

19. The method as illustrated and described.

20. The apparatus as illustrated and described.
